(19) United States
(12) Patent Application Publication
(10) Pub. No.: US 2023/0076563 A1
(43) Pub. Date: Mar. 9, 2023

(54) LIQUID METAL DROP MASS MEASUREMENT AND METHODS THEREOF

(71) Applicant: XEROX CORPORATION, NORWALK, CT (US)

(72) Inventors: Joseph C. SHEFLIN, Macedon, NY (US); Peter KNAUSDORF, Henrietta, NY (US)

(73) Assignee: XEROX CORPORATION, NORWALK, CT (US)

(21) Appl. No.: 17/447,174

(22) Filed: Sep. 8, 2021

(51) Int. Cl. B22F 10/85; B33Y 10/00; B33Y 50/02; B22F 10/22; B22D 23/00; B29C 64/118; B29C 64/393

(52) U.S. Cl. CPC B22F 10/85; B33Y 10/00; B33Y 50/02; B22F 10/22; B22D 23/003; B29C 64/118; B29C 64/393

(57) ABSTRACT

A method of controlling drop mass in a liquid ejector is disclosed which includes advancing a printing material feed source to introduce a quantity of a printing material into a liquid ejector, counting a quantity of ticks produced by an encoder coupled to the printing material source during a time period to calculate a mass of the printing material, counting a quantity of pulses produced by the liquid ejector during the time period, and entering into a control system the quantity of ticks produced by the encoder and the quantity of pulses produced by the liquid ejector. The method may include comparing the quantity of printing material calculated by using the quantity of ticks produced by the encoder to the quantity of printing material measured by using a level sensing system. The method of controlling drop mass in a liquid ejector may include steps performed by a microprocessor.

### TECHNICAL FIELD

The present teachings relate generally to liquid metal jetting drop-on-demand (DOD) printing and, more particularly, to a drop mass measurement and control system and methods for use within a liquid metal jetting DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, particularly one that prints a metal or metal alloy, ejects a small drop of liquid aluminum alloy when a firing pulse is applied. Using this technology, a 3D part can be created from aluminum or another alloy by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

In such 3D printers, the jetting start-up process may require an operator be available to perform the procedure. This process includes the ejector jet, also referred to as a pump or crucible, being brought up to an elevated temperature, for example 825° C., filling the pump with a metal such as aluminum, and being brought through various jetting “break-in” and “drop mass” routines before it is ready to use. An example drop mass routine may be conducted across different print frequencies, from about 100 to about 400 Hz, prior to printing. A drop mass routine may include printing 10,000 jetted aluminum drops and weighing the total mass of all drops. An example target or goal may be to have a drop mass of 1.45 grams for 10 k drops at 300 Hz at start-up.

During the drop mass routine at start-up, the pulse width and voltage of the firing pulse can be manually adjusted to achieve the desired drop mass of 1.45 grams. The process of weighing the jetted drop mass and tuning the machine parameters of pulse width and voltage can be time consuming. In addition to being time consuming, the manual process of adjusting drop mass can lead to mistakes caused by the operator. It is also established that the drop mass may change throughout the print job. Currently, there is no drop mass monitoring or control during printing. Typically, the drop mass will “fall-off” or drop during printing, often up to 20% during printing, possibly due to oxide building around the inner diameter of the nozzle orifice while printing as well as other defects. This drop can lead to part build geometry issues as well as compromise the structural integrity of the part.

Thus, there is a need for a method or process to enable a reduced machine start-up time without a need to weigh jetted material, which eliminates operator weighing errors, provides improved part consistency, and jetting performance throughout a job by maintaining consistent drop mass throughout a print job, and improves repeatability of part to part builds.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of controlling drop mass in a liquid ejector is disclosed. The method of controlling drop mass in a liquid ejector also includes advancing a printing material feed source to introduce a quantity of a printing material into a liquid ejector. The method of controlling drop mass in a liquid ejector also includes counting a quantity of ticks produced by an encoder coupled to the printing material source during a time period to calculate a mass of the printing material. The method of controlling drop mass in a liquid ejector also includes counting a quantity of pulses produced by the liquid ejector during the time period. The method also includes entering into a control system the quantity of ticks produced by the encoder and the quantity of pulses produced by the liquid ejector.

The method of controlling drop mass in a liquid ejector also includes where the encoder is externally coupled to a motor that advances the printing material feed source. The encoder may be integrated within a motor that advances the printing material feed source. The printing material source may be a wire or a rod. A quantity of printing material is determined by a calibration process, the calibration process may include determining a mass per encoder ticks prior to a printing operation by weighing a quantity of printing material advanced by the printing material source per a known quantity of ticks produced by the encoder coupled to the printing material source. The method of controlling drop mass in a liquid ejector may include measuring a quantity of printing material introduced into the liquid ejector directly by using a level sensing system configured to directly measure the quantity of printing material held within the liquid ejector. The method of controlling drop mass in a liquid ejector may include adjusting a voltage amplitude controlling the pulses produced by the liquid ejector to control the drop mass ejected by the liquid ejector. Adjusting the voltage amplitude controlling the pulses produced by the liquid ejector may be completed before a print job is started, after a print job is started, or a combination thereof. The method of controlling drop mass in a liquid ejector may include adjusting a pulse width controlling the pulses produced by the liquid ejector to control the drop mass ejected by the liquid ejector. Adjusting the pulse width controlling the pulses produced by the liquid ejector may be completed before a print job is started, after a print job is started, or a combination thereof. The method of controlling drop mass in a liquid ejector may include determining an average drop mass delivered by the liquid ejector from the quantity of ticks produced by the encoder and the quantity of pulses produced by the liquid ejector as completed by a microprocessor coupled to the control system. The printing material may include metal, metallic alloys, or a combination thereof. The printing material may include a plastic

Another method of controlling drop mass in a liquid ejector is disclosed. The method of controlling drop mass also includes advancing a printing material source to introduce a quantity of a printing material into a liquid ejector. The method of controlling drop mass also includes measuring a quantity of printing material introduced into the liquid ejector directly by using a level sensing system configured to directly measure the quantity of printing material held within the liquid ejector. The method of controlling drop mass also includes counting a quantity of ticks produced by an encoder coupled to the printing material source during a time period to calculate a mass of the printing material. The mass also includes counting a quantity of pulses produced by the liquid ejector during the time period. The method of controlling drop mass also includes comparing the quantity of printing material calculated by using the quantity of ticks produced by the encoder to the quantity of printing material measured by using the level sensing system. The method of controlling drop mass also includes entering into a control system the quantity of ticks produced by the encoder and the quantity of pulses produced by the liquid ejector.

The method of controlling drop mass in a liquid ejector may include where the printing material source is a wire. The printing material may alternatively include metal, metallic alloys, or a combination thereof. The printing material may include a plastic. The method of controlling drop mass in a liquid ejector may include determining an average drop mass delivered by the liquid ejector from the quantity of ticks produced by the encoder and the quantity of pulses produced by the liquid ejector, and comparing the quantity of printing material calculated by using the quantity of ticks produced by the encoder to the quantity of printing material measured by using the level sensing system as completed by a microprocessor.

Another method of controlling drop mass in a liquid ejector is disclosed. The method of controlling drop mass also includes advancing a printing material source to introduce a quantity of a printing material into a liquid ejector. The method of controlling drop mass also includes heating the printing material within the liquid ejector to cause a solid to change to a liquid within the ejector with a heating element. The method of controlling drop mass also includes counting a quantity of ticks produced by an encoder coupled to the printing material source during a time period to calculate a mass of the printing material. The method of controlling drop mass also includes supplying one or more pulses of power to a coil wrapped at least partially around the liquid ejector to cause one or more drops of liquid printing material to be jetted from the liquid ejector. The method of controlling drop mass also includes counting a quantity of pulses produced by the liquid ejector during the time period. The method of controlling drop mass also includes entering into a control system the quantity of ticks produced by the encoder and the quantity of pulses produced by the liquid ejector.

A computer readable medium is disclosed that may include instructions which includes a computer readable medium which also includes a method for advancing a printing material feed source to introduce a quantity of a printing material into a liquid ejector. The computer readable medium also includes counting a quantity of ticks produced by an encoder coupled to the printing material source during a time period to calculate a mass of the printing material. The computer readable medium also includes counting a quantity of pulses produced by the liquid ejector during the time period. The computer readable medium also includes determining an average drop mass delivered by the liquid ejector from the quantity of ticks produced by the encoder and the quantity of pulses produced by the liquid ejector. The computer readable medium also includes adjusting a voltage amplitude controlling the pulses produced by the liquid ejector to change the drop mass ejected by the liquid ejector. The method may include adjusting a pulse width controlling the pulses produced by the liquid ejector to change the drop mass ejected by the liquid ejector. The drop mass may be changed to meet a predetermined target drop mass. The method may be performed continuously during a printing operation.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid ejector jet of a 3D printer (e.g., a MHD printer and/or multi jet printer), according to an embodiment.

FIG. 2 is a schematic showing a drop mass measurement and control system for use in a metal jetting printer, according to an embodiment.

FIG. 3 is a data plot illustrating the monitoring of unadjusted drop mass in grams per 10,000 drops vs. number of pulses, according to an embodiment.

FIG. 4 is a plot representing a drop mass controller system during a typical print job, according to an embodiment.

FIG. 5 is a flowchart illustrating a method of measuring and controlling drop mass in metal jetting printer, according to an embodiment.

FIG. 6 is a flowchart illustrating a method of measuring and controlling drop mass in metal jetting printer, according to an embodiment.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In drop-on-demand (DOD) or three-dimensional (3D) a small drop of liquid aluminum or other metal or metal alloy is ejected when a firing pulse is applied. Using this printing technology, a 3D part can be created from aluminum or another alloy by ejecting a series of drops which bond together to form a continuous part. During a typical printing operation, the raw printing material wire feed can be replenished to the pump inside an ejector using a continuous roll of aluminum wire. The wire printing material may be fed into the pump using standard welding wire feed equipment, rod, or other means of introduction. As printing occurs and new material is fed into the pump, contaminants or other machine contaminations builds within the pump or ejector throughout the print run, as a function of total throughput of printing material. Along with drop mass reduction throughout a printing run, other defects such as degraded jetting performance, nozzle or machine contamination, level sensor faults, additional printer maintenance, shut down, or contamination related catastrophic failure may occur. While systems exist to counteract dross accumulation in similar ejector and printer systems, they are fairly complex and require manual operations involving multiple operators or manual intervention.

The print-head, nozzle, or ejector used in 3D printer embodiments described herein is a single-nozzle head and some internal components within the head or ejector require periodic replacement. A typical period for nozzle replacement is in 8-hour intervals. As part of the nozzle replacement routine on printers of this type, the print-head must go through a start-up process. This process includes being brought up to temperature, usually 825° C., filled with aluminum or other printing material, and brought through a jetting “break-in” and “drop mass” setup routine before it is ready to use. The start-up process requires an operator be available to perform the procedure. The desire is that the time it takes to perform this start-up process to be as short as possible, so that the time that the machine is available to print parts during operation is maximized.

A portion of the start-up process that takes considerable time is conducting a drop mass measurement routine. The jetting break-in and drop mass measurement routine consists of jetting at a lower frequency, for example 50 Hz, for 5 minutes to allow the pump to reach equilibrium performance. Once this initial break-in routine is complete the frequency is increased to 300 Hz, where the drop mass measurement routine is conducted. The manual drop mass measurement routine is conducted with a specialized jetting program that jets 10,000 drops that must be collected by an operator and weighed on a scale. If the drop mass is low, in a typical instance below 1.45 grams, the pulse firing voltage and/or pulse width is increased, and another drop mass is collected and weighed. If the drop mass is high (above 1.45 grams), the pulse firing voltage and/or pulse width is decreased, and the routine is repeated. The drop mass routine is conducted until a drop mass of 1.45 grams is achieved. While in the described routine, 1.45 grams is the target or goal drop mass measurement, alternate printing systems having either different drop mass targets or ejector dimensions may have alternate drop mass measurement targets, which are predetermined by a computer processor or by operator input, for example. Once the desired drop mass is achieved, then the operator will begin printing a part. Once part printing begins the drop mass is not monitored or corrected. When the part is completed the drop mass routine is conducted again. The drop mass is typically reduced during part printing as an oxide will form around the inner diameter of the nozzle. The slicer or part build rules and drop spacing is determined based on a certain drop mass. This slicer or part build provides layer by layer information to direct printing operations. As the drop mass changes during a print run this can cause the part to build incorrectly.

Disclosed herein is a method using a control scheme and order of operations that utilizes an encoder coupled to the printing material wire or rod feed system to determine the total wire throughput compared against the number of pulses fired while the printer is jetting. The use of an encoder is employed in conjunction with a numeric constant which equals the “mass per encoder pulse” which may be derived from an initial calibration procedure. As the pump or ejector reservoir level may be measured with the use of a laser system, for example, an acuity AR-100 laser, the signal from such a laser measures the distance to the level of molten aluminum. As the distance to the level increases, i.e. the pump level drops, the system calls for wire to feed into the pump. The encoder coupled to the printing material feed measures the input volume of wire into the pump, and the firing pulses to the coil from the PRIO board will be monitored and counted. PRIO refers to a Path Related Impulse Output, which is a controller acronym. It may be assumed that for a typical printing operation that the number of pulses counted refers to the PRIO (Path Related Impulse Output) pulses, or in other words, one pulse is equivalent to one drop fired from the printhead. In certain embodiments, one drop may be the result of more than one pulse, or a plurality of pulses, such as print heads or printers that include ejector designs that require, for example, a pre-pulse and a firing pulse, or a design that requires a “burst” of short pulses to cause ejection. It should be noted that a pulse may additionally be defined as any signal, train or combination of signals, or other input that results in the ejection of one drop of material, regardless of the design of the ejector. In an instance where there is a pre-pulse or burst of pulses, it would be known how many jetted drops are fired during the print job whether the ratio of pulses is 1:1, 2:1, 10:1, and so on, and therefore an appropriate scale factor could be used in the counting algorithm or other portion of the operating method as described herein. This allows for a recording, monitoring, calculation, and control for measuring drop mass during jetting without the need to weigh any jetted material, interrupt printing runs, or conduct time-consuming start-up procedures. Such an automated start-up drop mass control scheme or routine as described herein can be automatically conducted by an operator and control settings determined from the controller. The drop mass can be monitored during a customer print job as well. This allows for a control system to vary the firing pulse width and/or voltage during a print job to maintain the desired drop mass. Maintaining drop mass during the part build in such a manner leads to improved customer part build quality and repeatability. Advantages of such a method include reduced machine start-up time without the need to weigh jetted material, elimination of manual drop mass weighing errors, improved part consistency by maintaining drop mass during an entire print job, improvements in jetting performance throughout the run by maintaining a consistent drop size from print run start to print run finish, enhancing part to part build repeatability with respect to part weight and geometry, and minimization of any impact relating to poor jetting, which can lead to early machine shut down.

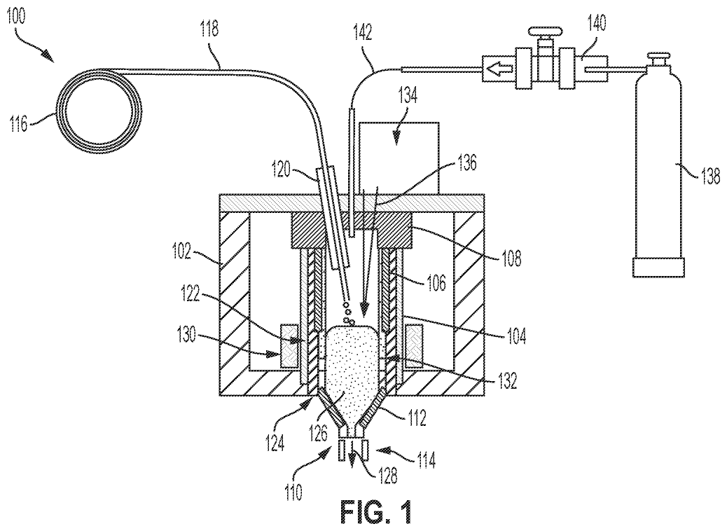

FIG. 1 depicts a schematic cross-sectional view of a single liquid ejector jet of a 3D printer (e.g., a MHD printer and/or multi jet printer), according to an embodiment. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity). A printing material 126 may be introduced into the inner volume 132 of the ejector 104. The printing material 126 may be or include a metal, a polymer, a plastic, or the like. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another embodiment, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another embodiment, there may be relative rotation between the nozzle 110 and the substrate around one or two additional axes, such that there is four or five axis position control. In certain embodiments, both the nozzle 110 and the substrate may move. For example, the substrate may move in X and Y directions, while the nozzle 110 moves up and/or down in a Y direction.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another embodiment, the gas may be or include nitrogen. The gas may include less than about 10% oxygen, less than about 5% oxygen, or less than about 1% oxygen. In at least one embodiment, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one embodiment, the enclosure 102 may be hermetically sealed. In another embodiment, the enclosure 102 may not be hermetically sealed. In one embodiment, the ejector 104, the heating elements 112, the power source, the coils, the substrate, additional system elements, or a combination thereof may be positioned at least partially within the enclosure 102. In another embodiment, the ejector 104, the heating elements 112, the power source, the coils, the substrate, additional system elements, or a combination thereof may be positioned at least partially outside of the enclosure 102.

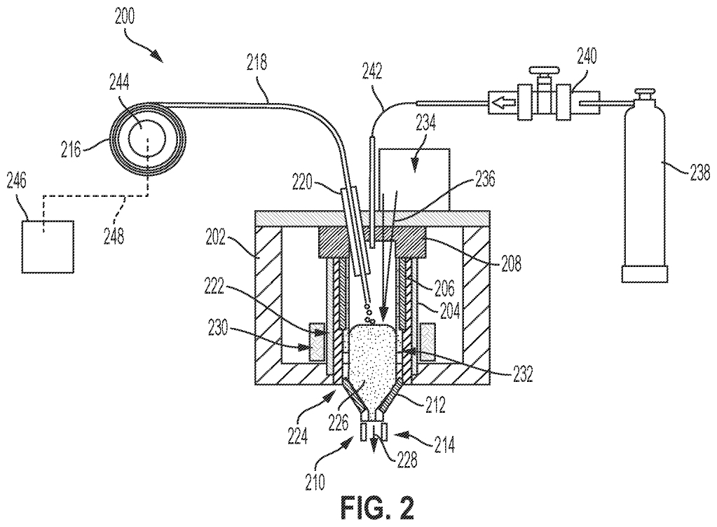

FIG. 2 is a schematic showing a drop mass measurement and control system for use in a metal jetting printer, according to an embodiment. FIG. 2 illustrates a schematic cross-sectional view of a single liquid ejector jet of a 3D printer (e.g., a MHD printer and/or multi jet 3D printer), FIG. 2 shows a portion of a type of drop-on-demand (DOD) or three-dimensional (3D) printer 200. The 3D printer or liquid ejector jet system 200 may include an ejector (also referred to as a body, print-head, or pump chamber, or a “one-piece” pump) 204 within an outer ejector housing 202, also referred to as a lower block. The ejector 204 may define an inner volume 232 (also referred to as an internal cavity). A printing material 226 may be introduced into the inner volume 232 of the ejector 204. The printing material 226 may be or include a metal, a polymer, or the like. For example, the printing material 226 may be or include aluminum or aluminum alloy, introduced via a printing material supply 216 or spool of a printing material wire feed 218, in this case, an aluminum wire. The liquid ejector jet system 200 further includes a first inlet 220 within a pump cap or top cover portion 208 of the ejector 204 whereby the printing material wire feed 218 is introduced into the inner volume 232 of the ejector 204. The ejector 204 further defines a nozzle 210, an upper pump 222 area and a lower pump 224 area. One or more heating elements 212 are distributed around the pump chamber 204 to provide an elevated temperature source and maintain the printing material 226 in a molten state during printer operation. The heating elements 212 are configured to heat or melt the printing material wire feed 218, thereby changing the printing material wire feed 218 from a solid state to a liquid state (e.g., printing material 226) within the inner volume 232 of the ejector 204. The three-dimensional 3D printer 200 and ejector 204 may further include an air or argon shield 214 located near the nozzle 210, and a water coolant source 230 to further enable nozzle and/or ejector 204 temperature regulation. The liquid ejector jet system 200 further includes a level sensor 234 system which is configured to detect the level of molten printing material 226 inside the inner volume 232 of the ejector 204 by directing a detector beam 236 towards a surface of the printing material 226 inside the ejector 204 and reading the reflected detector beam 236 inside the level sensor 234.

The 3D printer 200 may also include a power source, not shown herein, and one or more metallic coils 206 enclosed in a pump heater that are wrapped at least partially around the ejector 204. The power source may be coupled to the coils 206 and configured to provide an electrical current to the coils 206. An increasing magnetic field caused by the coils 206 may cause an electromotive force within the ejector 204, that in turn causes an induced electrical current in the printing material 226. The magnetic field and the induced electrical current in the printing material 226 may create a radially inward force on the printing material 226, known as a Lorenz force. The Lorenz force creates a pressure at an inlet of a nozzle 210 of the ejector 204. The pressure causes the printing material 226 to be jetted through the nozzle 210 in the form of one or more liquid drops 228.

The 3D printer 200 may also include a substrate, not shown herein, that is positioned proximate to (e.g., below) the nozzle 210. The ejected drops 228 may land on the substrate and solidify to produce a 3D object. The 3D printer 200 may also include a substrate control motor that is configured to move the substrate while the drops 228 are being jetted through the nozzle 210, or during pauses between when the drops 228 are being jetted through the nozzle 210, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another embodiment, the ejector 204 and/or the nozzle 210 may be also or instead be configured to move in one, two, or three dimensions. In other words, the substrate may be moved under a stationary nozzle 210, or the nozzle 210 may be moved above a stationary substrate. In yet another embodiment, there may be relative rotation between the nozzle 210 and the substrate around one or two additional axes, such that there is four or five axis position control. In certain embodiments, both the nozzle 210 and the substrate may move. For example, the substrate may move in X and Y directions, while the nozzle 210 moves up and/or down in a Y direction.

The 3D printer 200 may also include one or more gas-controlling devices, which may be or include a gas source 238. The gas source 238 may be configured to introduce a gas. The gas may be or include an inert gas, such as helium, neon, argon, krypton, and/or xenon. In another embodiment, the gas may be or include nitrogen. The gas may include less than about 10% oxygen, less than about 5% oxygen, or less than about 1% oxygen. In at least one embodiment, the gas may be introduced via a gas line 242 which includes a gas regulator 240 configured to regulate the flow or flow rate of one or more gases introduced into the three-dimensional 3D printer 200 from the gas source 238. For example, the gas may be introduced at a location that is above the nozzle 210 and/or the heating element 212. This may allow the gas (e.g., argon) to form a shroud/sheath around the nozzle 210, the drops 228, the 3D object, and/or the substrate to reduce/prevent the formation of oxide (e.g., aluminum oxide) in the form of an air shield 214. Controlling the temperature of the gas may also or instead help to control (e.g., minimize) the rate that the oxide formation occurs.

The liquid ejector jet system 200 may also include an enclosure 202 that defines an inner volume (also referred to as an atmosphere). In one embodiment, the enclosure 202 may be hermetically sealed. In another embodiment, the enclosure 202 may not be hermetically sealed. In one embodiment, the ejector 204, the heating elements 212, the power source, the coils, the substrate, additional system elements, or a combination thereof may be positioned at least partially within the enclosure 202. In another embodiment, the ejector 204, the heating elements 212, the power source, the coils, the substrate, additional system elements, or a combination thereof may be positioned at least partially outside of the enclosure 202.

While the liquid ejector jet system 200 is quite similar to the system 200 depicted in FIG. 1, the liquid ejector jet system 200 in FIG. 2 includes several distinctive features in comparison. The printing material supply 216 includes a encoder 244 coupled to the printing material supply 216. The encoder 244 in this embodiment is shown coupled as an external encoder 244, but other embodiments may incorporate a printing material supply 216 with an integrated encoder as part of a motor used to drive or advance a printing material supply 216 or may have multiple encoders coupled to multiple printing material supplies 216 as needed. Still other embodiments may include a single encoder for multiple motors used for driving one or more printing material supplies 216. The encoder 244 is coupled by a connection 248 to a separate central processing unit, or microprocessor 246 which is employed to count ticks from the encoder 244 and number of pulses, adjust various printing operation parameters, and report data or information related to the various parameters, values, or drop mass in accordance with the methods for measuring and controlling drop mass in metal jetting printer as described herein.

The encoder 244 on the printing material supply 216 is used in conjunction with the firing pulses to determine the jetted drop mass without the need to weigh jetted material. In certain embodiments, a start-up drop mass routine can be automatically run by an operator and control settings determined from the controller. A control system, controlled by the microprocessor 246, is used to monitor the drop mass and determines the firing pulse width and/or voltage during a print job to maintain the desired drop mass throughout the entire part build. Currently, the print job or printer operation runs in an “open-loop” drop mass that can drift during the run. In embodiments described herein, the use of the encoder 244 to monitor the wire fed into the pump chamber 204 is employed as a means of determining drop mass without the need for weighing jetted aluminum and also serves to monitor and/or adjust the drop mass during a print job or part build. The encoder 244 can either be used from the motor delivering the input wire to the pump or can be an external encoder mounted to a drive wheel portion of the 3D printer 200. The encoder 244 is used to monitor the length of wire fed into the pump chamber 204 during jetting. In addition to using an encoder 244 the firing (PRIO) pulses delivered to the coil may also be monitored to track the number of drops fired. Using this information. the drop mass of the system either during the drop mass routine during start-up or during the actual customer print job may be monitored without the need for directly weighing the drop mass.

In experimentation with embodiments having such an encoder and setup, an external encoder was installed to the wire feed wheel to monitor the length of wire fed into the pump. The number of pulses that fire the coil and thus eject a drop of printing material, are collected into the system as well. A microprocessor or central processing unit controller is used to control the system. An initial calibration procedure was used to determine the number of encoder pulses corresponding to the wire fed in grams. The procedure used was to feed wire into the open air, and not into the print head, at a rate similar to printing. The wire is weighed independently to establish a known mass, and the encoder pulse count for the amount of wire feed is recorded. For example, if the wire feed weighs 15.1895 grams and there were 54609 encoder pulses from the wire encoder this would yield 15.1895 grams divided by 54609 encoder pulses which is equal to 0.00027815 grams per encoder pulse. During printing operations, this information can be used to calculate the cumulative mass of the part build and the drop mass per 10,000 ticks or encoder counts. Therefore, if a printed part uses 222383 ticks of wire, then the total mass of the part is 222383 multiplied by 0.00027815 grams/encoder pulse which equals 61.86 grams total. If 61.86 grams is divided by the number of pulses, which corresponds to jetted drops, or 456745, the result is 0.000135 grams per drop. This value may then be normalized to a standard of 10 k pulses by multiplying it by 10,000 which results in 1.35 grams per 10K pulses. Thus, in this example, the part is printing with too little mass and requires an adjustment in either voltage and/or pulse width or another parameter to bring the drop mass to the desired target or goal. This example also illustrates the potential advantages of tracking drop mass during printing as it is preferable to build the part with an appropriate drop mass for purposes of accuracy, rather than at a sub-optimal drop mass. Alternatively, the wire or printing material could be derived solely from wire dimensions, physical properties, and encoder count. Additional correlation of this method could be partially based on level sense information as appropriate. In this example, the ejector cavity is filled with metal. The required number of drops, in this example, 10,000 drops are fired, the level of printing material in the ejector is reduced, refilled via a wire feed or other printing material source feed. As the wire printing material feed stops, the level sense can correlate a quantity of printing material in some exemplary embodiments. Calibration procedures as described herein may be performed before, during or after a print job, or alternatively, whenever the input printing material physically changes, such as at the beginning of a print job, after a printing material change, during a print job for troubleshooting purposes, and the like.

Table 1 shows the described encoder pulse method of determined drop mass as compared to the direct scale method with both methods measuring the same drop mass across a number of jetting frequency settings. The last two columns of the chart include a comparison of the calculated drop mass method with the direct scale method for samples for 10,000 jetted drops (drop mass).

TABLE 1

| | | | | Actual |
|---|---|---|---|---|
| | PRIO | Encoder | Calculated | Weighed |
| Frequency | Pulses | Pulses | drop mass | Drop Mass |
| 100 | 10000 | 5711 | 1.589 | 1.5922 |
| 200 | 10000 | 5586 | 1.554 | 1.5529 |
| 300 | 10000 | 5310 | 1.477 | 1.4785 |
| 400 | 10000 | 4925 | 1.370 | 1.3683 |

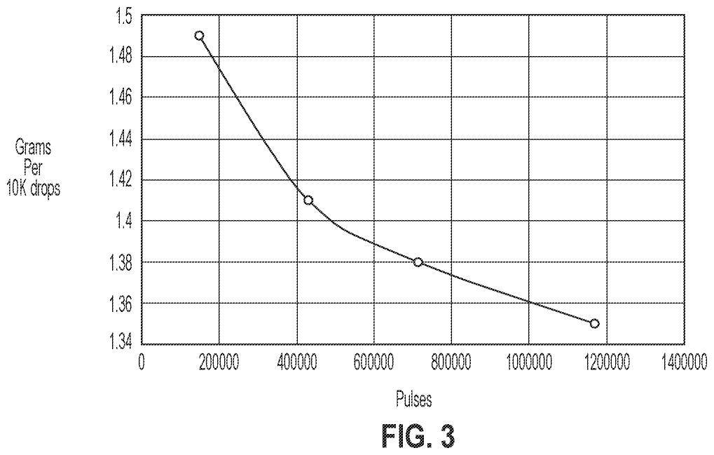

FIG. 3 is a data plot illustrating the monitoring of unadjusted drop mass in grams per 10,000 drops vs. number of pulses, according to an embodiment. The data illustrated in FIG. 3 shows calculated drop mass data over the course of a typical customer print job. As the number of pulses, and therefore the print job time progresses, it should be noted that the drop mass falls or decreases during the run which may result in a light part, or potentially other defects. A weighed drop mass after such a print run would confirm a lower drop mass as well. Data such as this could be used to inform and adjust the drop mass during printing runs or printing operations.

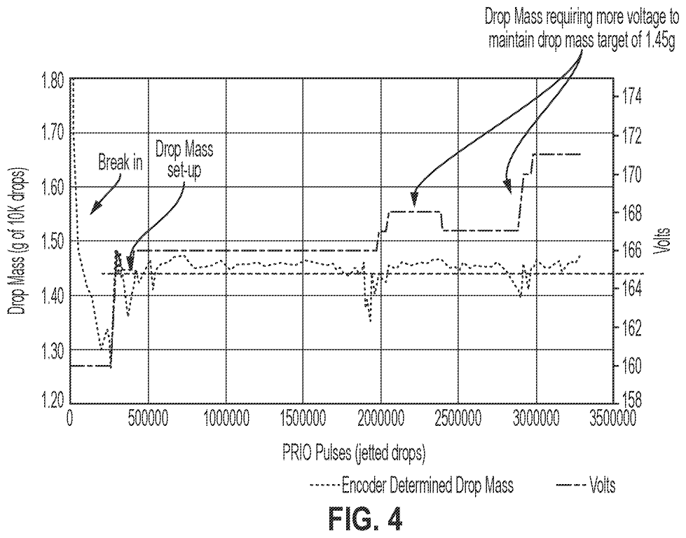

FIG. 4 is a plot representing a drop mass controller system during a typical print job, according to an embodiment. The data plotted in FIG. 4 illustrates a similar duration of a typical customer print job, however this time the voltage of the firing pulses is adjusted during the job, according to one or more of the methods disclosed herein. It should be noted that with the use of a method for measuring and controlling drop mass, the drop mass remains consistent throughout the print run. After an initial break in period, followed by a drop mass set-up operation and subsequent printing operations, the drop mass begins to fall. In response, the controller or microprocessor, or electronic processor can adjust the voltage of the firing pulses. This voltage adjustment leads to a higher drop mass, and thus an improved customer part build quality, consistent part build weight, and repeatability from part to part. Certain embodiments may incorporate an adjustment of the pulse width, pulse shape, the voltage, or a combination thereof in order to maintain a predetermined target drop mass during a print operation.

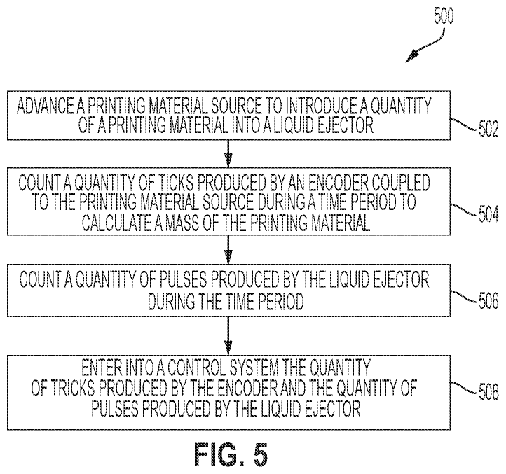

FIG. 5 is a flowchart illustrating a method of measuring and controlling drop mass in metal jetting printer, according to an embodiment. The method of determining and controlling drop mass in a liquid ejector 500 includes an initial step to advance a printing material source to introduce a quantity of a printing material into a liquid ejector 502, count a quantity of ticks produced by an encoder coupled to the printing material source during a time period to calculate a mass of the printing material 504, and count a quantity of pulses produced by the liquid ejector during the time period 506. Next, an average drop mass delivered by the liquid ejector is calculated from the quantity of ticks produced by the encoder and the quantity of pulses produced by the liquid ejector 508. The method of determining and controlling drop mass in a liquid ejector 500 may include an encoder which is externally coupled to a motor that advances the printing material feed source in certain embodiments. Alternate embodiments may include an encoder which is integrated within a motor that advances the printing material feed source. The printing material source is a wire, or alternatively a rod, in some embodiments of the method of determining and controlling drop mass in a liquid ejector 500. The method of determining and controlling drop mass in a liquid ejector 500 may also include an instance where the quantity of printing material is determined by a calibration process, the calibration process comprising determining a mass per encoder ticks prior to a printing operation by weighing a quantity of printing material advanced by the printing material source per a known quantity of ticks produced by the encoder coupled to the printing material source. The method of determining and controlling drop mass in a liquid ejector 500 may include, in certain embodiments, a measurement of a quantity of printing material introduced into the liquid ejector directly by using a level sensing system configured to directly measure the quantity of printing material held within the liquid ejector. In other embodiments, the method of determining and controlling drop mass in a liquid ejector 500 may further include adjusting a voltage amplitude controlling the pulses produced by the liquid ejector to control the drop mass ejected by the liquid ejector or alternatively adjusting the voltage amplitude controlling the pulses produced by the liquid ejector is completed before a print job is started, after a print job is started, or a combination thereof. The method of determining and controlling drop mass in a liquid ejector 500 may also include adjusting a pulse width controlling the pulses produced by the liquid ejector to control the drop mass ejected by the liquid ejector or alternatively adjusting the voltage amplitude controlling the pulses produced by the liquid ejector is completed before a print job is started, after a print job is started, or a combination thereof. Additional embodiments of the method of determining and controlling drop mass in a liquid ejector 500 may include calculating an average drop mass delivered by the liquid ejector from the quantity of ticks produced by the encoder and the quantity of pulses produced by the liquid ejector is completed by a microprocessor. The printing material used in the method of determining and controlling drop mass in a liquid ejector 500 may include metal, metallic alloys, or a combination thereof, or alternatively a plastic.

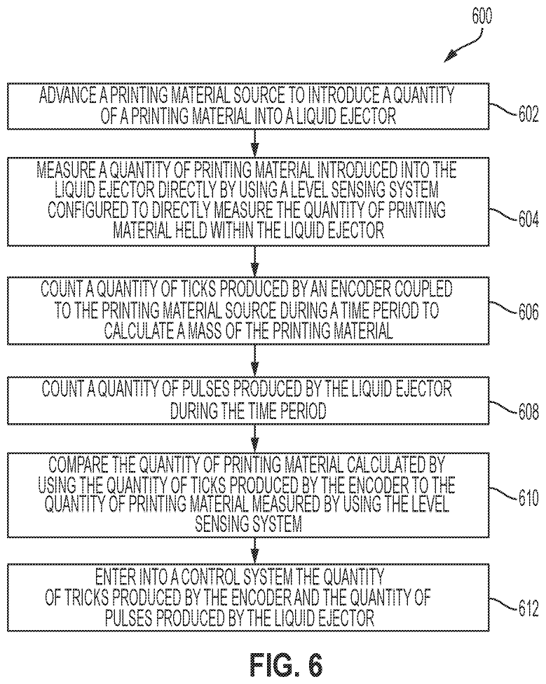

FIG. 6 is a flowchart illustrating a method of measuring and controlling drop mass in metal jetting printer, according to an embodiment. A method of determining and controlling drop mass in a liquid ejector 600 is illustrated in FIG. 6, which includes a step to advance a printing material source to introduce a quantity of a printing material into a liquid ejector 602, followed by a step to measure a quantity of printing material introduced into the liquid ejector directly by using a level sensing system configured to directly measure the quantity of printing material held within the liquid ejector 604. Next, the method of determining and controlling drop mass in a liquid ejector 600 includes counting a quantity of ticks produced by an encoder coupled to the printing material source during a time period to calculate a mass of the printing material 606, counting a quantity of pulses produced by the liquid ejector during the time period 608, and comparing the quantity of printing material calculated by using the quantity of ticks produced by the encoder to the quantity of printing material measured by using the level sensing system 610. Finally, the method of determining and controlling drop mass in a liquid ejector 600 includes a step to calculate an average drop mass delivered by the liquid ejector from the quantity of ticks produced by the encoder and the quantity of pulses produced by the liquid ejector 612. Alternate embodiments of the method of determining and controlling drop mass in a liquid ejector 600 may include a printing material source that is a wire or a rod. The method of determining and controlling drop mass in a liquid ejector 600 may includes a printing material which is a metal, a metallic alloy, or a combination thereof. Alternatively, the printing material in the method of determining and controlling drop mass in a liquid ejector 600 may include a plastic printing material. The method of determining and controlling drop mass in a liquid ejector 600 may include additional steps in some embodiments, where one or more of the steps of the method are completed by a microprocessor. Alternate embodiments of a method of determining and controlling drop mass in a liquid ejector may include advancing a printing material source to introduce a quantity of a printing material into a liquid ejector, heating the printing material within the liquid ejector to cause a solid to change to a liquid within the ejector with a heating element, counting a quantity of ticks produced by an encoder coupled to the printing material source during a time period to calculate a mass of the printing material, supplying one or more pulses of power to a coil wrapped at least partially around the liquid ejector to cause one or more drops of liquid printing material to be jetted from the liquid ejector, counting a quantity of pulses produced by the liquid ejector during the time period, and calculating an average drop mass delivered by the liquid ejector from the quantity of ticks produced by the encoder and the quantity of pulses produced by the liquid ejector using a microprocessor or electronic processors.

In various embodiments, a hardware configuration may include the microprocessor or computer readable medium which can be used to perform one or more of the processes described above. The hardware configuration may include any type of mobile devices, such as smart telephones, laptop computers, tablet computers, cellular telephones, personal digital assistants, etc. Further the hardware configuration can include one or more processors of varying core configurations and clock frequencies. The hardware configuration may also include one or more memory devices that serve as a main memory during operations, calculations, or simulations as described herein. For example, during operation, a copy of the software that supports the above-described operations can be stored in one or more memory devices. One or more peripheral interfaces, such as keyboards, mice, touchpads, computer screens, touchscreens, etc., for enabling human interaction with and manipulation of the hardware configuration may also be included. Exemplary hardware configurations can also include a data bus, one or more storage devices of varying physical dimensions and storage capacities, such as flash drives, hard drives, random access memory, etc., for storing data, such as images, files, and program instructions for execution by the one or more processors. One or more network interfaces for communicating via one or more networks, such as Ethernet adapters, wireless transceivers, or serial network components, for communicating over wired or wireless media using protocols may further be included.

Additionally, hardware configurations in certain embodiments can include one or more software programs that enable the functionality described herein. The one or more software programs can include instructions that cause the one or more processors to perform the processes, functions, and operations described herein related to calculations, inputs, simulations, adjusting of pulse width, adjusting of pulsed waveform generation, and combinations thereof. Copies of the one or more software programs can be stored in the one or more memory devices and/or on in the one or more storage devices. Likewise, the data utilized by one or more software programs can be stored in the one or more memory devices and/or on in the one or more storage devices.

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, or EEPROM. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art. In other embodiments, a non-transitory computer-readable medium may include instructions, that when executed by a hardware processor, causes the hardware processor to perform operations to execute one or more of the methods described within a printing system.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of controlling drop mass in a liquid ejector, comprising:
advancing a printing material feed source to introduce a quantity of a printing material into a liquid ejector;
counting a quantity of ticks produced by an encoder coupled to the printing material source during a time period to calculate a mass of the printing material;
counting a quantity of pulses produced by the liquid ejector during the time period; and
entering into a control system the quantity of ticks produced by the encoder and the quantity of pulses produced by the liquid ejector.

2. The method of controlling drop mass in a liquid ejector of claim 1, wherein the encoder is externally coupled to a motor that advances the printing material feed source.

3. The method of controlling drop mass in a liquid ejector of claim 1, wherein the encoder is integrated within a motor that advances the printing material feed source.

4. The method of controlling drop mass in a liquid ejector of claim 1, wherein the printing material source is a wire.

5. The method of controlling drop mass in a liquid ejector of claim 1, wherein the printing material source is a rod.

6. The method of controlling drop mass in a liquid ejector of claim 1, wherein a quantity of printing material is determined by a calibration process, the calibration process comprising determining a mass per encoder ticks prior to a printing operation by weighing a quantity of printing material advanced by the printing material source per a known quantity of ticks produced by the encoder coupled to the printing material source.

7. The method of controlling drop mass in a liquid ejector of claim 1, further comprising measuring a quantity of printing material introduced into the liquid ejector directly by using a level sensing system configured to directly measure the quantity of printing material held within the liquid ejector.

8. The method of controlling drop mass in a liquid ejector of claim 1, further comprising adjusting a voltage amplitude controlling the pulses produced by the liquid ejector to control the drop mass ejected by the liquid ejector.

9. The method of controlling drop mass in a liquid ejector of claim 8, wherein adjusting the voltage amplitude controlling the pulses produced by the liquid ejector is completed before a print job is started, after a print job is started, or a combination thereof.

10. The method of controlling drop mass in a liquid ejector of claim 1, further comprising adjusting a pulse width controlling the pulses produced by the liquid ejector to control the drop mass ejected by the liquid ejector.

11. The method of controlling drop mass in a liquid ejector of claim 10, wherein adjusting the pulse width controlling the pulses produced by the liquid ejector is completed before a print job is started, after a print job is started, or a combination thereof.

12. The method of controlling drop mass in a liquid ejector of claim 1, further comprising determining an average drop mass delivered by the liquid ejector from the quantity of ticks produced by the encoder and the quantity of pulses produced by the liquid ejector as completed by a microprocessor coupled to the control system.

13. The method of controlling drop mass in a liquid ejector of claim 1, wherein the printing material comprises metal, metallic alloys, or a combination thereof.

14. The method of controlling drop mass in a liquid ejector of claim 1, wherein the printing material comprises a plastic.

15. A method of controlling drop mass in a liquid ejector, comprising:
advancing a printing material source to introduce a quantity of a printing material into a liquid ejector;
measuring a quantity of printing material introduced into the liquid ejector directly by using a level sensing system configured to directly measure the quantity of printing material held within the liquid ejector;
counting a quantity of ticks produced by an encoder coupled to the printing material source during a time period to calculate a mass of the printing material;
counting a quantity of pulses produced by the liquid ejector during the time period;
comparing the quantity of printing material calculated by using the quantity of ticks produced by the encoder to the quantity of printing material measured by using the level sensing system; and
entering into a control system the quantity of ticks produced by the encoder and the quantity of pulses produced by the liquid ejector.

16. The method of controlling drop mass in a liquid ejector of claim 15, wherein the printing material source is a wire.

17. The method of controlling drop mass in a liquid ejector of claim 15, wherein the printing material comprises metal, metallic alloys, or a combination thereof.

18. The method of determining and controlling drop mass in a liquid ejector of claim 15, wherein the printing material comprises a plastic.

19. The method of controlling drop mass in a liquid ejector of claim 15, further comprising determining an average drop mass delivered by the liquid ejector from the quantity of ticks produced by the encoder and the quantity of pulses produced by the liquid ejector, and comparing the quantity of printing material calculated by using the quantity of ticks produced by the encoder to the quantity of printing material measured by using the level sensing system as completed by a microprocessor.

20. A method of controlling drop mass in a liquid ejector, comprising:
advancing a printing material source to introduce a quantity of a printing material into a liquid ejector;
heating the printing material within the liquid ejector to cause a solid to change to a liquid within the ejector with a heating element;
counting a quantity of ticks produced by an encoder coupled to the printing material source during a time period to calculate a mass of the printing material;
supplying one or more pulses of power to a coil wrapped at least partially around the liquid ejector to cause one or more drops of liquid printing material to be jetted from the liquid ejector;
counting a quantity of pulses produced by the liquid ejector during the time period; and
entering into a control system the quantity of ticks produced by the encoder and the quantity of pulses produced by the liquid ejector.

21. A computer readable medium comprising instructions which, when executed by at least one electronic processor, configures the at least one electronic processor to execute a method for controlling drop mass in a liquid ejector in a printing system, the method comprising:
advancing a printing material feed source to introduce a quantity of a printing material into a liquid ejector;
counting a quantity of ticks produced by an encoder coupled to the printing material source during a time period to calculate a mass of the printing material;
counting a quantity of pulses produced by the liquid ejector during the time period;
determining an average drop mass delivered by the liquid ejector from the quantity of ticks produced by the encoder and the quantity of pulses produced by the liquid ejector; and
adjusting a voltage amplitude controlling the pulses produced by the liquid ejector to change the drop mass ejected by the liquid ejector.

22. The method of claim 21, further comprising adjusting a pulse width controlling the pulses produced by the liquid ejector to change the drop mass ejected by the liquid ejector.

23. The method of claim 21, wherein the drop mass is changed to meet a predetermined target drop mass.

24. The method of claim 21, wherein the method is performed continuously during a printing operation.
